(19) United States
(12) Patent Application Publication
(10) Pub. No.: US 2025/0355106 A1
(43) Pub. Date: Nov. 20, 2025

(54) EXPLOITING MULTI-BOUNCE SCATTERING TO INCREASE THE FIELD-OF-VIEW OF MILLIMETER-WAVE RADAR IMAGING

(71) Applicants: William Marsh Rice University, Houston, TX (US); Carnegie Mellon University, Pittsburgh, PA (US)

(72) Inventors: Nishant Mehrotra, Houston, TX (US); Ashutosh Sabharwal, Houston, TX (US); Divyanshu Pandey, Houston, TX (US); Akarsh Prabhakara, Pittsburgh, PA (US); Yawen Liu, Pittsburgh, PA (US); Swarun Kumar, Pittsburgh, PA (US)

(73) Assignees: William Marsh Rice University, Houston, TX (US); Carnegie Mellon University, Pittsburgh, PA (US)

(21) Appl. No.: 19/210,924

(22) Filed: May 16, 2025

Related U.S. Application Data
(60) Provisional application No. 63/649,021, filed on May 17, 2024.

(51) Int. Cl. G01S 13/48; G01S 13/46; G01S 13/89

(52) U.S. Cl. CPC G01S 13/48; G01S 13/89; G01S 2013/462

(57) ABSTRACT

A method for exploiting multi-bounce scattering to increase the field-of-view of millimeter-wave radar imaging without prior environment knowledge is disclosed. The method includes transmitting a radar signal based on a fixed transmit beam pattern and receiving a plurality of reflections of the transmitted radar signal from a plurality of objects in an environment, wherein the reflections may be single-bounce reflections, double-bounce reflections, and triple-bounce reflections. Additionally, the method includes performing a single-bounce matched filtering to localize a first plurality of objects based on the received single-bounce reflection, performing a double-bounce matched filtering to localize a second plurality of objects based on the received double-bounce reflection and the localized first plurality of objects, and performing a triple-bounce matched filtering to localize a third plurality of objects based on the received triple-bounce reflection, the localized first plurality of objects and, the localized second plurality of objects. Further, a map that includes the plurality of objects localized by the single-bounce matched filtering, the double-bounce matched filtering, and the triple-bounce matched filtering is generated.

### CROSS REFERENCE TO RELATED APPLICATIONS

This application claims priority to U.S. provisional patent application No. 63/649,021, filed May 17, 2024, which is herein incorporated by reference.

### STATEMENT REGARDING FEDERALLY SPONSORED RESEARCH OR DEVELOPMENT

The invention was made with government support under: Grant Number IUSE-2215082 and Grant Number IUSE-2211803 awarded by the National Science Foundation (NSF). The government has certain rights in the invention.

### BACKGROUND

Millimeter-wave systems have a limited imaging field-of-view due to their high directionality and reliance on single-bounce paths that scatter once from objects in the environment before being received at the system. Further, existing millimeter-wave systems that utilize specific triple-bounce paths require prior environment knowledge from additional sensors like lidars.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method that includes transmitting, using a radar, a radar signal based on a fixed transmit beam pattern and receiving, using the radar, a plurality of reflections of the transmitted radar signal from a plurality of objects in an environment, wherein the reflections may be single-bounce reflections, double-bounce reflections, and triple-bounce reflections and wherein no data about environment is received. Further, the method includes performing a single-bounce matched filtering to localize a first plurality of objects based on the received single-bounce reflection, performing a double-bounce matched filtering to localize a second plurality of objects based on the received double-bounce reflection and the localized first plurality of objects, and performing a triple-bounce matched filtering to localize a third plurality of objects based on the received triple-bounce reflection, the localized first plurality of objects and, the localized second plurality of objects. Additionally, the method includes generating a map that includes the plurality of objects localized by the single-bounce matched filtering, the double-bounce matched filtering, and the triple-bounce matched filtering.

In general, in one aspect, embodiments disclosed herein relate to a system including a millimeter wave radar, wherein the millimeter wave radar transmits a plurality of radar signals in a set of fixed directions, and wherein the millimeter wave radar receives a plurality of reflected signals, wherein the plurality of reflected signals is the plurality of radar signals reflected from a plurality of surrounding objects and wherein no data about environment is received. Further, the system includes a computer communicably connected to the millimeter wave radar, the computer comprising a processor and a memory, the memory storing instructions that, when executed by the processor, cause the processor to perform a single-bounce matched filtering to localize a first plurality of objects based on the received single-bounce reflection, perform a double-bounce matched filtering to localize a second plurality of objects based on the received double-bounce reflection and the localized first plurality of objects, and perform a triple-bounce matched filtering to localize a third plurality of objects based on the received triple-bounce reflection, the localized first plurality of objects and, the localized second plurality of objects. Additionally, a map is generated, where the map includes the plurality of objects localized by the single-bounce matched filtering, the double-bounce matched filtering, and the triple-bounce matched filtering.

In general, in one aspect, embodiments disclosed herein relate to a non-transitory computer readable medium storing a set of instructions executable by a computer processor. The set of instructions includes the functionality for performing a single-bounce matched filtering to localize a first plurality of objects based on the received single-bounce reflection, performing a double-bounce matched filtering to localize a second plurality of objects based on the received double-bounce reflection and the localized first plurality of objects, and performing a triple-bounce matched filtering to localize a third plurality of objects based on the received triple-bounce reflection, the localized first plurality of objects and, the localized second plurality of objects. Additionally, a map is generated, where the map includes the plurality of objects localized by the single-bounce matched filtering, the double-bounce matched filtering, and the triple-bounce matched filtering.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a computer system in accordance with one or more embodiments.

FIG. 2 shows a diagram of the multi-bounce scattering system in accordance with one or more embodiments.

FIG. 3 shows a flowchart of the multi-bounce scattering system in accordance with one or more embodiments.

FIG. 4 shows a diagram of the multi-bounce scattering system in accordance with one or more embodiments.

FIG. 5 shows a diagram of the multi-bounce scattering system detecting a ghost point in accordance with one or more embodiments.

FIGS. 6A and 6B show a diagram of the multi-bounce scattering system performing a double-bounce and triple-bounce in accordance with one or more embodiments.

FIGS. 7A and 7B show an exemplary diagram of the multi-bounce scattering system in accordance with one or more embodiments.

FIGS. 8A and 8B show an exemplary diagram of the multi-bounce scattering system in accordance with one or more embodiments.

FIGS. 9A and 9B show an exemplary diagram of the multi-bounce scattering system in accordance with one or more embodiments.

### DETAILED DESCRIPTION

Embodiments disclosed herein generally relate to a multi-bounce scattering. Further, one or more embodiments disclosed herein relate to a multi-bounce scattering method that exploits natural multi-bounce scattering in the environment to image objects beyond the single-bounce field-of-view of millimeter-wave systems and enabling the millimeter-wave systems to see around-corners, behind-the-system, behind-occlusions, etc. Further, the method exploits all orders of multi-bounce paths and requires no additional hardware or prior knowledge about the environment. As used herein “includes” means “includes but is not limited to.”

In one aspect, one or more embodiments the method includes a sequential iterative procedure to extract arbitrary-order multi-bounce paths from the combination of all paths received at the system. Further, the method images objects at their ground-truth locations via multi-bounce without prior knowledge of the environment. The implementation of the method on a commercial millimeter-wave multiple-input multiple-output radar testbed shows that our method enables imaging of beyond-field-of-view objects, with similar or better performance as state-of-the-art, without additional hardware or prior environment knowledge.

The embodiments disclosed herein generally relate to scenarios including, but not limited to, hidden object localization. In such scenarios, estimating the position of objects not in direct line-of-sight of the interrogating system, for instance objects hidden behind the system or located around-corners, is critical to system operation. Examples include traffic navigation at intersections with limited visibility, locating non-line-of-sight humans trapped in rubble, etc. Amongst multiple sensing systems for such tasks, radio detection and ranging (e.g., radar) systems form an integral part due to their ability to penetrate through impediments such as fog and smoke, which occlude object positioning with light-based systems, such as cameras and light detection and ranging (e.g., lidar) systems.

Radar systems operate by radiating electromagnetic signals in radio and microwave frequencies into the environment and receiving reflections of radiated signals from objects in the environment. The reflected signals received at the radar are used to estimate the position of objects with respect to the radar system. In particular, radar systems utilize the time shift between the transmitted and received signal to estimate the object's position with respect to the radar.

Traditional millimeter wave (“mmWave”) radars are limited to sense objects that are directly illuminated by the radar and scatter the radar's signals directly back to the radar. In practice, however, a large fraction of the incoming signals are scattered to other intermediate objects in the environment and undergo multiple bounces before being received back at the radar.

Conventional radar signal processing assumes the signals transmitted by the radar reflect off an object once in the environment before being received at the radar receiver, henceforth termed single-bounce radar processing. A feature of single-bounce radar signal processing is that it limits the field-of-view of the radar system to estimate the locations only of objects in direct line-of-sight (LOS) to the radar. Real-world signal propagation, however, occurs across a multitude of paths reflecting from multiple objects, henceforth referred to as multi-bounce scattering.

While prior art has explored using multi-bounce for radar sensing, prior art made specific assumptions on the number of bounces, required additional hardware, or assumed the prior knowledge of the environment. The disclosed method, called Hydra, does not require the above assumptions, thus enabling a single standalone mm Wave radar to sense objects beyond its single-bounce field-of-view.

Embodiments disclosed herein describe a method to harness natural multi-bounce scattering in the environment to image objects beyond the single-bounce field-of-view of a radar system, enabling the radar system to see around-corners and behind-the-radar. Further, the method requires no additional hardware or prior knowledge about the environment. The disclosed method that exploits double-bounce and triple-bounce paths improves the median localization error for human targets standing outside the radar's field-of-view by 2 to 10 times over traditional single-bounce methods.

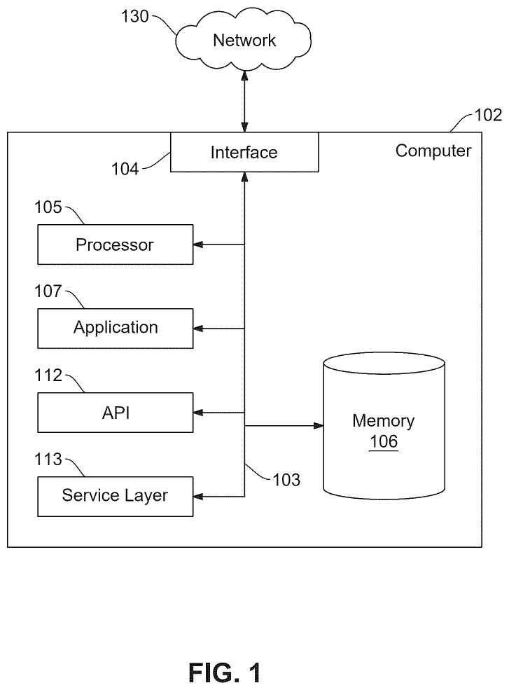

FIG. 1 depicts a block diagram of a computer system (102) used to provide computational functionalities, control functionalities, or both associated with algorithms, methods, functions, processes, flows, and procedures in this disclosure, according to one or more embodiments. The illustrated computer (102) is intended to encompass any suitable computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (102) may include a computer that includes an input device, such as a keypad, keyboard, touch screen, or other device that may accept user information, and an output device that conveys information associated with the operation of the computer (102), including digital data, visual, or audio information (or a combination of information), or a GUI.

The computer (102) may serve in a role as a client, network component, a server, a database or other persistency, or any other suitable component (or a combination of roles) of a computer system for performing the subject matter described in the instant disclosure. The illustrated computer (102) is communicably coupled with a network (130). In some implementations, one or more components of the computer (102) may be configured to operate within environments, including cloud-computing-based, local, global, or other environment (or a combination of environments).

At a high level, the computer (102) is an electronic computing device operable to receive, transmit, process, store, or manage data and information associated with the described subject matter. According to some implementations, the computer (102) may also include or be communicably coupled with an application server, e-mail server, web server, caching server, streaming data server, business intelligence (BI) server, or other server (or a combination of servers).

The computer (102) may receive requests over network (130) from a client application (for example, executing on another computer (102) and responding to the received requests by processing the said requests in an appropriate software application. In addition, requests may also be sent to the computer (102) from internal users (for example, from a command console or by other appropriate access method), external or third-parties, other automated applications, as well as any other appropriate entities, individuals, systems, or computers.

Each of the components of the computer (102) may communicate using a system bus (103). In some implementations, any or all of the components of the computer (102), both hardware or software (or a combination of hardware and software), may interface with each other or the interface (104) (or a combination of both) over the system bus (103) using an application programming interface (API) (11) or a service layer (113) (or a combination of the API (112) and service layer (113). The API (112) may include specifications for routines, data structures, and object classes. The API (112) may be either computer-language independent or dependent and refer to a complete interface, a single function, or even a set of APIs. The service layer (113) provides software services to the computer (102) or other components (whether or not illustrated) that are communicably coupled to the computer (102). The functionality of the computer (102) may be accessible for all service consumers using this service layer. Software services, such as those provided by the service layer (113), provide reusable, defined business functionalities through a defined interface. For example, the interface may be software written in JAVA, C++, or other suitable language providing data in extensible markup language (XML) format or another suitable format. While illustrated as an integrated component of the computer (102), alternative implementations may illustrate the API (112) or the service layer (113) as stand-alone components in relation to other components of the computer (102) or other components (whether or not illustrated) that are communicably coupled to the computer (102). Moreover, any or all parts of the API (112) or the service layer (113) may be implemented as child or sub-modules of another software module, enterprise application, or hardware module without departing from the scope of this disclosure.

The computer (102) includes an interface (104). Although illustrated as a single interface (104) in FIG. 1, two or more interfaces (104) may be used according to particular needs, desires, or particular implementations of the computer (102). The interface (104) is used by the computer (102) for communicating with other systems in a distributed environment that are connected to the network (130). Generally, the interface (104) includes logic encoded in software or hardware (or a combination of software and hardware) and operable to communicate with the network (130). More specifically, the interface (104) may include software supporting one or more communication protocols associated with communications such that the network (130) or interface's hardware is operable to communicate physical signals within and outside of the illustrated computer (102).

The computer (102) includes at least one computer system (105). Although illustrated as a single computer system (105) in FIG. 1, two or more processors may be used according to particular needs, desires, or particular implementations of the computer (102). Generally, the computer system (105) executes instructions and manipulates data to perform the operations of the computer (102) and any algorithms, methods, functions, processes, flows, and procedures as described in the instant disclosure.

The computer (102) also includes a memory (106) that holds data for the computer (102) or other components (or a combination of both) that may be connected to the network (130). For example, memory (106) may be a database storing data consistent with this disclosure. Although illustrated as a single memory (106) in FIG. 1, two or more memories may be used according to particular needs, desires, or particular implementations of the computer (102) and the described functionality. While memory (106) is illustrated as an integral component of the computer (102), in alternative implementations, memory (106) may be external to the computer (102).

The application (107) is an algorithmic software engine providing functionality according to particular needs, desires, or particular implementations of the computer (102), particularly with respect to functionality described in this disclosure. For example, application (107) may serve as one or more components, modules, applications, etc. Further, although illustrated as a single application (107), the application (107) may be implemented as multiple applications (107) on the computer (102). In addition, although illustrated as integral to the computer (102), in alternative implementations, the application (107) may be external to the computer (102).

There may be any number of computers (102) associated with, or external to, a computer system containing computer (102), wherein each computer (102) communicates over network (130). Further, the term “client,” “user,” and other appropriate terminology may be used interchangeably as appropriate without departing from the scope of this disclosure. Moreover, this disclosure contemplates that many users may use one computer (102), or that one user may use multiple computers (102).

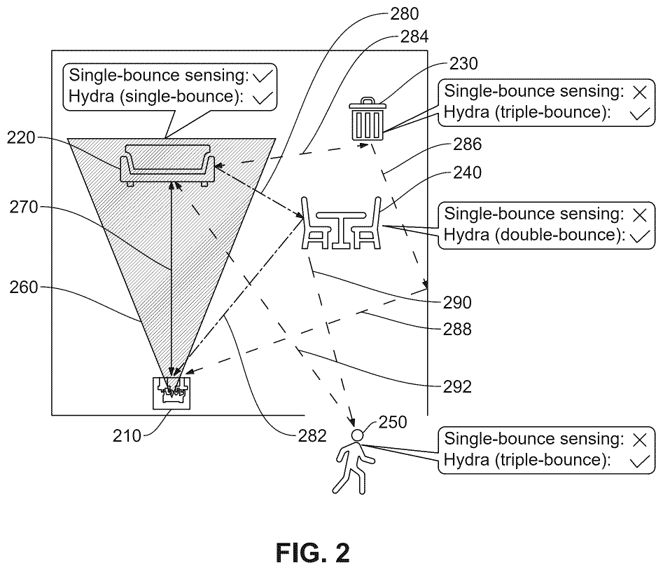

FIG. 2 shows an exemplary use of multi-bounce scattering in accordance with one or more embodiments. Specifically, the mmWave radar (210) transmits the transit beam (260) that directly illuminates only the sofa (220). The transmit beam (260) transmitted towards sofa, bounces off of the sofa and travels back to the mmWave radar (210). Such wave (270) is a single-bounce wave which may be detected by both, the traditional single-bounce sensing and the Hydra system.

Further, the transmit beam (260) may also be reflected from the sofa (220) and travel to the table (240) and then reflect from the table (240) back to the mmWave radar (210). The two reflections (280, 282) constitute the double-bounce reflections. The double-bounce reflections may be detected by Hydra and cannot be detected using the single-bounce sensing. In this case, the sofa (220) is first localized using the single-bounce and then subsequently treated as a source for the double-bounce to localize the table (240).

Additionally, the transmit beam (260) that reflect from the sofa (220) to the trash can (230) to the wall and then to the mmWave radar, or from the sofa (220) to the table (240) to the person (250) and then to the mmWave radar, both are the multi-bounce reflections. Specifically, waves 284, 286, and 288 are triple-bounce reflections and waves 280, 290, 292, and 270 are quadruple-bounce reflection.

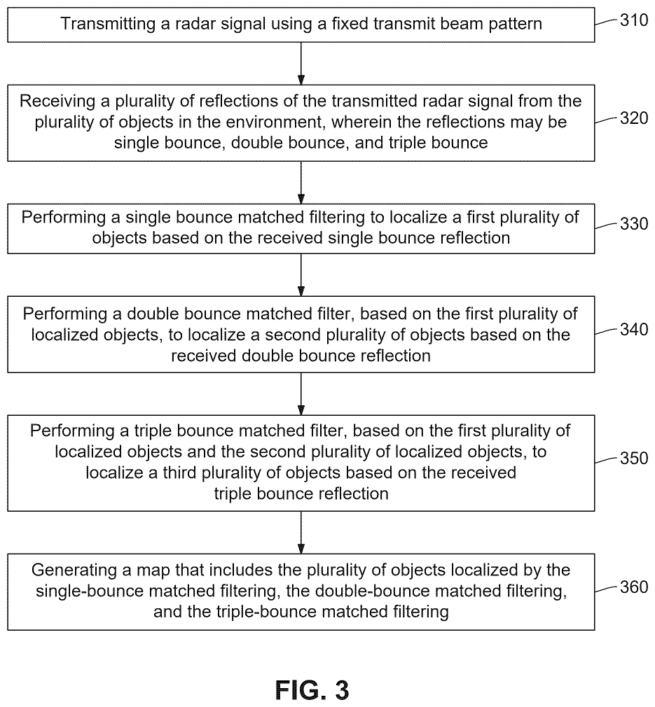

FIG. 3 shows a flowchart describing the millimeter-wave method. The method includes a mathematical model for diffuse multi-bounce scattering, which provides the basis for multi-bounce spatial domain matched filtering to localize beyond-field-of-view (“FoV”) objects. Additionally, the method includes a sequential detection and localization pipeline that separately detects objects along single-bounce, double-bounce and triple-bounce paths, and then uses prior detections as anchors to localize objects using multi-bounce despite their weaker power. The overall algorithmic flow is first described for a radar transmit beamforming towards a fixed direction, before extending the algorithm to a beam steering radar that beamforms in a set of fixed directions.

In one or more embodiments, in Step 310, a mmWave radar transmits a radar signal using a fixed transmit beam pattern. Specifically, the mmWave radar includes multiple transmit and receive antennas. The transmit and receive antennas are arranged in multiple input multiple output (“MIMO”) array. A fixed transmit beam is formed by applying a set of beamforming weights to the transmit antennas. This process steers the transmitted energy towards a specific azimuthal direction. This beamforming configuration defines the radar's transmit FoV, which includes a main lobe, where the majority of the signal energy is concentrated, and side lobes, which carry lower signal energy. A known radar waveform is modulated by the beamforming weights to produce a beamformed transmit signal.

Further, after the transmit beam is configured, the radar transmits the modulated signal into the environment. The transmitted signal propagates directionally and illuminates the region within the bounds of the transmit beam pattern. The objects located within the transmit FoV, including both, the main lobe and side lobes, may reflect the radar signal back towards the receiver. However, the objects outside the FoV will not be directly illuminated and therefore cannot be detected by conventional single-bounce radar processing.

Additionally, the MIMO radar comprises a transmit array and a receive array with transmit (T) and receive (R) elements respectively, where x(t) denotes the transmit signal, beamformed in a fixed direction, with respect to the radar's position, via the T×1 beamforming weights vector w_{TX}. The fixed direction may be defined by an azimuthal angle between the fixed direction and a nominal line perpendicular to a nominal axis of the radar.

In Step 320, a plurality of reflections of the transmitted radar signal is received from the plurality of objects in the environment. Specifically, after transmitting the radar signal into the environment, the mmWave radar captures reflections of the transmitted signal that have undergone a single-bounce, a double-bounce, and triple-bounce. The reflections are received by the mmWave radar's antenna array and stored as time-domain data, forming a 3D radar data cube. The 3D radar data cube may be indexed by receiver element, time sample, and chirp index. The R×1 vector of received signals at the radar can be modeled as the sum of transmit signal reflections along paths that scatter once from objects in the environment (single-bounce), twice in the environment (double-bounce), thrice (triple-bounce), etc.

$$y ( t ) = {y}_{SB} ( t ) + {y}_{DB} ( t ) + {y}_{TB} ( t ) + …$$

In Step 330, the single-bounce matched filtering is performed to localize a first plurality of objects based on the received single-bounce reflection. The first plurality of the objects includes all objects that are located in the FoV of the radar's transmitted beam. The localization includes applying matched filtering to the received signal data and using the known transmit waveform and beamforming weights. Specifically, the mmWave radar implements adjoint inversion process, where the received frequency-domain data are correlated with candidate single-bounce paths. Each candidate single-bounce path corresponds to the path from the mmWave radar to the point in the environment and back.

Further, this step produces a reflectivity estimate across a discretized spatial map, where each point where each map point represents the likelihood of a strong radar reflection originating from that location. To distinguish actual objects from noise or clutter, the system then applies a two-dimensional ordered-statistics constant false alarm rate (“OS-CFAR”) detection algorithm. The OS-CFAR detection algorithm computes the target-to-clutter ratio (TCR) corresponding to each location p in the environment, where the target power at p is defined as the reflectivity intensity, |ôₚ|², and the clutter power is the median value of reflectivity intensities of points in a local neighborhood around p. The computed TCR is then compared to a threshold, empirically chosen as a half of the maximum TCR amongst all single-bounce reflectivities.

In one or more embodiments, the OS-CFAR detector identifies peaks in the reflectivity map that are significantly above the local background level, producing a final set of detected object locations. If an object is detected at a higher range but same angle as another detection, the higher range object is zeroed out since such a detection can only correspond to a false or mislocalized reflections and not a physical object. We denote the final set of locations of single-bounce object detections by S₁. These single-bounce detections form the initial anchor set for subsequent stages of multi-bounce processing.

In one or more embodiments, the single-bounce term y_{SB}(t) is given by the sum of signal reflections along paths of radar to the location in the environment and back to the radar. Assuming the radar is located at the origin, such single-bounce paths have delay proportional to the distance of location p, and attenuation dependent on the reflectivity and path loss corresponding to location p. Further, the model for y_{SB}(t)) is:

$${y}_{SB} ( t ) = {\sum }_{p} {σ}_{p} * {a}_{RX} ( {θ}_{p} ) * {a}_{TX}^{T} ( {θ}_{p} ) * {w}_{TX} x ( t - \frac{2 ‖ p ‖}{c} ) \qquad ( Equation 1 )$$

where a_{TX}(θₚ) and a_{RX}(θₚ) denote the T×1 and R×1 steering vectors of the radar's transmit and receive arrays, and ∥p∥ denotes the Euclidean norm of the location vector p. The goal of imaging is to extract the reflectivities σₚ, which non-zero magnitudes indicate the presence of an object at p.

In Step 340, the double-bounce matched filtering is performed to localize a second plurality of objects based on the first plurality of localized objects and the received double-bounce reflection. Specifically, the mmWave radar system extends its sensing capability by identifying additional objects through double-bounce reflections based on the initial set of objects localized through single-bounce processing. In this step, each object detected in the single-bounce stage is treated as a potential anchor or reflector that may have redirected radar signal energy toward regions not directly visible to the radar's transmit beam. For every such anchor point, the system determines two paths that describe a radar signal first traveling from the mmWave radar to the anchor, then bouncing to a second point in the environment, and finally returning to the mmWave radar.

To obtain the double-bounce reflections, the radar applies a dedicated matched filtering algorithm adjusted to the double-bounce path model. This filter correlates the received signal with the expected delay and direction profile of a signal that traverses the hypothesized two-way path, compensating for the combined path length and angular components. For each candidate location in the environment, the system evaluates the average double-bounce reflectivity by aggregating contributions across all anchor points. Importantly, this search excludes locations previously identified via single-bounce, and it focuses on regions outside the radar's direct beam, where objects may otherwise go undetected.

The resulting double-bounce reflectivity map is then processed using the OS-CFAR detector, similar to the one used in the single-bounce stage but calibrated for lower signal strengths. This step outputs a new set of object detection locations corresponding to targets that were not directly illuminated but are now located through the second order scattering interactions with known objects.

Specifically, to obtain the double-bounce model, the Equation 1 may be extended to double-bounce by considering paths of the form from the radar to anchor point to the now point and back to the radar, where the anchor point and the new point are at different locations. The time delay of such double-bounce paths is proportional to:

$${d}_{( p 1 , p 2 )} = ‖ {p}_{1} ‖ + ‖ {p}_{1} - {p}_{2} ‖ + ‖ {p}_{2} ‖ \qquad ( Equation 2 )$$

Further, the model for the double-bounce term is

$$( Equation 3 )$$

$${y}_{DB} ( t ) = {\sum }_{{p}_{1} \neq {p}_{2}} {σ}_{{p}_{1} , {p}_{2}} * {a}_{RX} ( {θ}_{{p}_{2}} ) * {a}_{TX}^{T} ( {θ}_{{p}_{1}} ) * {w}_{TX} x ( t - \frac{{d}_{( {p}_{1} , {p}_{2} )}}{c} )$$

where σₚ_{₁}_{,p}_{₂} denotes the combined reflectivity and path loss of the path from the radar to the anchor point to the new point and back to the radar.

The double-bounce reflectivity σₚ_{₁}_{,p}_{₂} is estimated as

$${σ}_{{p}_{1} , {p}_{2}} = \frac{1}{w} {\sum }_{w} ( {a}_{Tx}^{T} ( {θ}_{P} ) {W}_{Tx} ) * {e}^{j {w}^{\frac{dp ; {p}^{1}}{C}}} {a}_{Rx}^{H} ( {θ}_{{P}^{′}} ) {\overline{y}}_{D} ( W ) \qquad ( Equation 4 )$$

where y(w)=F (y(t)) is the element-wise Fourier transform of the received signal vector y(t) at frequency w, W denotes the total number of frequencies w in the radar's bandwidth, w_{TX} is the transmit beamforming weights vector, d₍ₚ_{₁}_{,p}_{₂}₎ is the term in Equation 2, a_{TX}(θₚ) and a_{RX} (σₚ) denote the transmit and receive steering vectors of the radar and for any complex vector x, x^{H} denotes its conjugate.

In Step 350, the triple-bounce matched filtering is performed to localize a third plurality of objects based on the first plurality of localized objects, the second plurality of localized objects, and the received triple-bounce reflection. After the identification of objects through single-bounce and double-bounce reflections, the radar system proceeds to localize additional out-of-view targets using the triple bounce paths. In this step, the system considers combinations of previously detected anchor points, specifically, pairs of single-bounce and double-bounce detections, and models radar signal paths that reflect successively off three surfaces. First from the radar to a single-bounce anchor, then to a double-bounce anchor, and finally to a third, unknown target location before returning to the radar. In some embodiments, the third unknown target does not have to be limited to a location in front of the radar, but may also include locations behind the radar, as long as the first or second location are in front of the radar.

The system applies a triple-bounce matched filtering operation that accounts for the cumulative delay and angular changes associated with these three-segment paths. For each hypothesized path defined by an anchor pair, the radar evaluates candidate triple-bounce locations by correlating the received signals with the expected signal structure of a triple-bounce reflection. As in the double-bounce stage, the resulting reflectivity estimates for each candidate points are averaged across all valid anchor combinations to enhance robustness and suppress noise.

To ensure independence between bounce stages, candidate triple-bounce points are restricted to locations that were not previously identified in either the single-bounce or double-bounce stages. Once the triple-bounce reflectivity map is computed, it is passed through the OS-CFAR detector to identify statistically significant peaks. The result is a new set of object detections corresponding to targets that are completely outside the radar's field-of-view, such as those located behind the radar or around corners and are visible only through triple-bounce scattering. These detections meaningfully expand the radar's environmental coverage, especially in cluttered or occluded scenarios where direct line-of-sight paths are unavailable.

Specifically, In one or more embodiments, the model can be extended to n^{th} bounce, for any n>0, along path radar from first bounce point to n^{th} bounce point and back to radar:

$$( Equation 5 )$$

$${y}_{DB} ( t ) = {\sum }_{{p}_{1} \neq {p}_{2} … \neq {p}_{n}} {σ}_{{p}_{1} … {p}_{n}} * {a}_{RX} ( {θ}_{{p}_{n}} ) * {a}_{TX}^{T} ( {θ}_{{p}_{1}} ) * {w}_{TX} x ( t - \frac{{d}_{( {p}_{1} … {p}_{n} )}}{c} )$$

The single-bounce returns greatly dominate over higher-order multi-bounce for all locations within the transmit beam pattern.

In one or more embodiments, to extract the reflectivities of locations outside the transmit beam pattern (single-bounce field-of-view), the measurements are processed iteratively after initial pre-processing (matched filtering with transmit signal x(t), followed by zero-Doppler extraction and optionally, background subtraction).

In one or more embodiments, in each n^{th} iteration, n^{th} bounce processing is performed in a subset of the environment (multi-bounce zone) where no objects were detected in any of the previous (n−1) iterations. Formally, n^{th} bounce processing is performed in zone

$${z}_{n} = {S}_{n - 1}^{c} ,$$

the complement of Sₙ₋₁, Which denotes the areas within which objects have been detected in previous (n−1) iterations.

In one or more embodiments, in the n^{th} iteration, imaging is performed in two steps. First, estimate σₚ_{₁} _{. . . p}_{ₙ} as

$${\hat{σ}}_{{p}_{1} … {p}_{n}} = {\sum }_{w} ( {a}_{TX} ( {θ}_{{p}_{1}} ) {w}_{TX} ) * {e}^{j {w}^{\frac{{d}_{( {p}_{1} … {p}_{n} )}}{c}}} {a}_{RX}^{H} ( {θ}_{{p}_{n}} ) * y ( w ) \qquad ( Equation 6 )$$

where y(w)=F (y(t)) is the element-wise Fourier transform of the received signal vector y(t). Then, the reflectivity estimates \hat{σ}ₚ_{₁}, . . . , \hat{σ}ₚ_{ₙ} obtained from previous (n−1) iterations are used to recover \hat{σ}pₙ, in two following ways.

In one or more embodiments, the first way may be decomposing \hat{σ}ₚ_{₁}, . . . , \hat{σ}ₚ_{ₙ} as the produce of all n individual reflectivities \hat{σ}ₚ_{₁}, . . . , \hat{σ}ₚ_{ₙ}=, and estimate |\hat{σ}ₚ_{₁}, . . . , \hat{σ}ₚ_{ₙ}| using least-squares optimization.

In one or more embodiments, the second way may be estimating magnitude |\hat{σ}ₚ_{ₙ}| using the sample mean

$$\vert {\hat{σ}}_{{p}_{n}} \vert = \frac{1}{{\prod }_{m ∈ \{ 1 … , n \}} \vert {S}_{M} \vert} {\sum }_{{p}_{1} … {p}_{n - 1}} {\hat{σ}}_{{p}_{1} … {p}_{n}} . \qquad ( Equation 7 )$$

In one or more embodiments, SM is set to be an empty set and the iterations are stopped when no new objects have been detected in the prior w iterations, for some meaningful value of w (e.g., w=2). Further, the objects are detected using standard radar object detectors, including but not limited to detectors that compute the target-to-clutter ratio (TCR) corresponding to each location p in the environment, where the target power at p is defined as the reflectivity intensity, −|\hat{σ}ₚ_{ₙ}|², and the clutter power is defined on the basis of the reflectivity intensities of points in a local neighborhood around p. The computed TCR is then compared to a threshold, and locations whose TCR exceeds the given threshold are classified as detected objects.

Finally, if an object is detected at a higher range but at the same angle as another detection, the higher range object is zeroed out since such a detection can only correspond to a “ghost” and not a physical object location, assuming that signal energy is mostly reflected by objects and does not penetrate through objects to a large extent,

The final output is the union of the reflectivity estimates across all iterations. The final set of detected objects after the above steps in the n^{th} iteration is denoted by Sₙ. The set Dₙ is defined as the set product up to the current iteration, i.e., Dₙ=S₁×S₂× . . . ×Sₙ=Dₙ₋₁×Sₙ.

In one or more embodiments, where the radar beamsteers in a set of fixed directions, given a set of transmit beamforming weights w∈W, the procedure in each of the above stages can be performed for each w∈W to yield an object detection set Sₙ (w). Subsequently, the union of sets Sₙ=∩w Sₙ (w) is passed to the (n+1)th stage.

While the sensing framework is conceptually extendable to arbitrary orders of multi bounce reflections, in practice, the radar system must impose a stopping criterion to ensure computational efficiency and signal reliability. As the number of bounces increases, the cumulative attenuation of the signal, due to both path loss and successive reflections, leads to a rapid decline in the received signal power. Empirical measurements show that by the time the quadruple bounce paths are considered, their power levels are often comparable to or below the environmental noise floor, rendering them unreliable for detection and localization.

To address this, the system monitors the signal strength and clutter-to-noise ratio of each successive bounce order. If the power of the resulting reflectivity estimates falls below a predefined threshold or fails to produce statistically significant detections after matched filtering and CFAR processing, the algorithm terminates further bounce processing. In the implementation evaluated in the Hydra study, the processing is capped at the triple-bounce stage, as fourth-bounce reflections were consistently found to be too weak to distinguish from background clutter.

This stopping criterion ensures that the radar avoids wasting computational resources on marginal data while maintaining a high degree of confidence in the detections it produces. It also prevents excessive error propagation from noisy or uncertain intermediate detections. As such, the system balances the theoretical capability of multi-bounce exploitation with the practical realities of mmWave signal attenuation and real-world clutter.

In Step 360, a map is generated to include the plurality of object localized by the single-bounce matched filtering, double-bounce matched filtering, and the triple-bounce matched filtering. In some embodiments, the map may be generated sequentially, so that one or more objects are added to the map after each degree of matched filtering. Alternatively, the map may be generated after reaching the stopping criterion. Further, the map may show the detected objects in front of and behind the mm Wave radar.

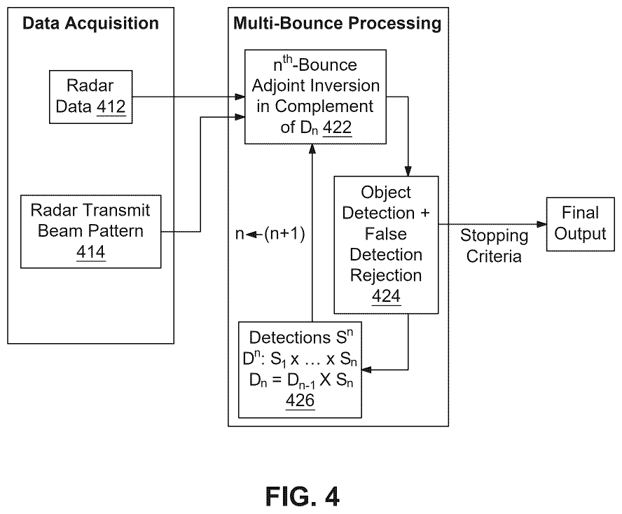

Turning to FIG. 4, a diagram of multi bounce scattering system is shown. The Hydra system begins with the acquisition of raw radar data (412), using a static millimeter-wave (mmWave) MIMO radar system. This data is organized into a radar data cube, a three-dimensional structure indexed by the number of receive antennas, the number of samples per chirp, and the number of chirps per frame. This cube captures the complex-valued time-domain reflections of the transmitted radar signal from the surrounding environment. It serves as the foundational input for all subsequent signal processing stages, preserving the spatial and temporal characteristics needed for accurate localization across different bounce orders.

To acquire the radar data, the radar system configures it transmit beam pattern (414), which defines the angular region of the environment that is illuminated by the outgoing signal. This is achieved by applying a predefined set of beamforming weights to the transmit antenna array, steering the main lobe of the transmitted energy toward a specific azimuth angle. The beam pattern establishes the radar's field-of-view for direct sensing and shapes the structure of multi-bounce paths by determining which parts of the environment can act as initial reflectors. This transmit beam remains fixed during the sensing cycle in Hydra's implementation, though it can be switched across multiple angles. The beam pattern configuration is essential for the adjoint inversion stage, as it determines the assumed angle of departure used in matched filtering for each bounce order.

Further, the acquired data is fed into the adjoint inversion stage (422), which performs matched filtering to estimate reflectivities for potential targets in the environment. For each bounce order n, the system models signal propagation paths that involve n reflections, then applies a frequency-domain matched filter to correlate the received radar data with those paths. This filtering compensates for the cumulative time delays and directional components of multi-bounce propagation, producing a spatial map of estimated reflectivity values that indicate how likely each location is to correspond to a real object. This process is repeated for each bounce order, starting with single-bounce (n=1), then double-bounce (n=2), and so on, each time using newly detected anchors to hypothesize more complex reflection paths creating the reflectivity map.

After the reflectivity map is generated for a given bounce order, Hydra applies a constant false alarm rate (CFAR) detection algorithm (424), specifically a 2D ordered-statistics CFAR (OS-CFAR). This stage evaluates each reflectivity peak against its local clutter background to determine whether it likely corresponds to a true object rather than noise or multipath artifacts. Detections that exceed a threshold, which may be set to half of the maximum target-to-clutter ratio for that bounce order, are accepted and compiled into a set Sₙ, representing confirmed object locations for bounce order n. This process helps eliminate false positives and maintains robustness in cluttered or low-signal environments.

Each bounce order results in a discrete set of detections, denoted as S₁, S₂, . . . , Sₙ, corresponding to objects localized through single-bounce, double-bounce, and higher-order reflections (426). These sets are cumulative and feed forward into the next stage of processing. For example, objects in S₁ are used as reflectors in estimating double-bounce paths for generating S₂, and pairs from S₁×S₂ are used to form triple-bounce paths for estimating S₃, etc. This structured, sequential approach enables the radar to iteratively extend its sensing range into regions that were not initially illuminated by the transmit beam.

After completing detection for a given bounce order, the system increments the bounce counter (n+n+1) and repeats the adjoint inversion and detection process for the next bounce order. This recursive loop continues until either a predefined maximum bounce order is reached, such as triple-bounce, or the received signal power becomes too weak to yield meaningful detections. The use of previous detections as anchors for the next bounce level ensures that the system builds up its environmental map in a controlled and physically plausible manner, avoiding speculative path modeling.

Hydra stops iterating when the additional bounce order fails to yield significant signal returns above the clutter or noise floor, or when further computation would produce diminishing returns. Experimental results in the paper show that reflections beyond third-bounce are typically too weak to be usable, leading to the system halting at the triple-bounce stage in practice. This control prevents overfitting to noise and keeps computation tractable, ensuring that all reported detections are physically meaningful and actionable.

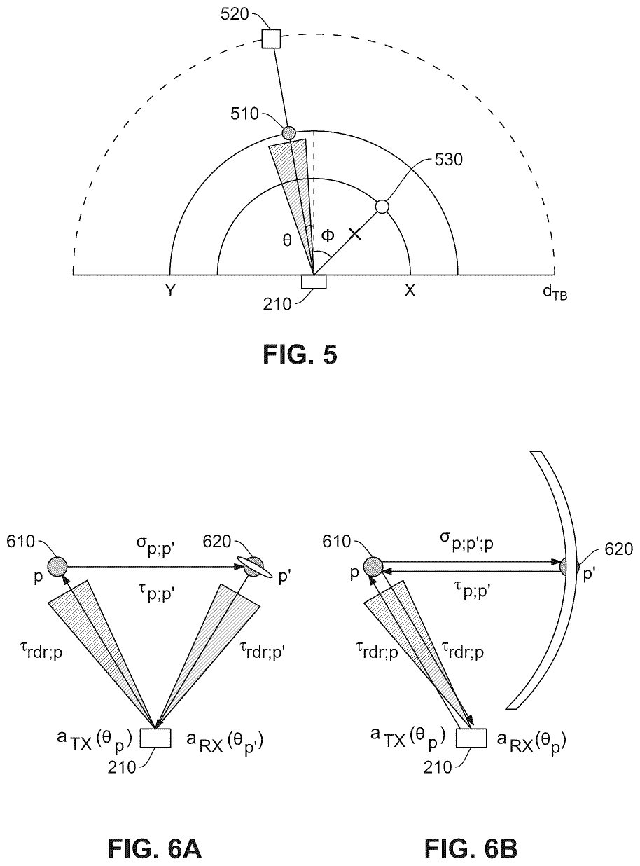

Turning to FIG. 5, FIG. 5 shows a diagram representing obtaining the data that represents the ghost point. In one or more embodiments, while traditional radar systems perform matched filtering under the assumption that all received reflections are from single-bounce paths, this simplification often leads to the appearance of ghost points (520), false or mislocalized object detections resulting from multi-bounce signals being interpreted as direct reflections. These ghosts (520) typically appear as mirror images or displaced versions of real objects (510), particularly in environments with strong reflectors like walls or furniture. In the Hydra system, this issue is explicitly addressed during the multi-bounce processing stage. After identifying anchor points (510, 530) through single-bounce detections, Hydra models higher-order reflection paths, such as double-bounce and triple-bounce sequences and applies matched filtering that accounts for their distinct propagation geometry. By correlating received signals with physically accurate multi-bounce path models, Hydra is able to localize objects (510, 530) to their true positions and avoid generating ghost points (520) altogether, removing the need for post-processing corrections that are common in conventional radar systems.

Turning to FIGS. 6A and 6B, FIGS. 6A and 6B show an exemplary diagram of intuitive geometric illustration of how Hydra's matched filtering process, the adjoint inversion, localizes objects along double-bounce and triple-bounce paths. In FIG. 6A, the double-bounce setup shows two points, p (610) and p′ (620), where the signal travels from the radar (210) to p (610), reflects to p′ (620), and returns to the radar (210). The matched filter used for double-bounce reflectivity estimation produces a peak along the direction defined by p′ (620), with the angular resolution determined by the receive array. Because the transmit beam is fixed and steered toward p (610), and the signal is only beamformed during reception for p′ (620), the angular resolution of the localization at p′ is limited to that of the receive array.

Further, FIG. 6B illustrates the triple-bounce scenario, where the signal reflects from p→p″→p′ before returning to the radar. The reflectivity is estimated at the candidate third location p″. However, because the triple-bounce matched filter depends only on the total path length through the three points and not uniquely on the location p″, the matched filter output for a given (p, p′) pair results in a reflectivity arc, a set of possible locations p″ equidistant in terms of path delay. To resolve the true location of p″, the system requires multiple such arcs from different (p, p′) pairs to intersect. This approach is critical for understanding how multi-bounce sensing can recover targets even with incomplete angular resolution, and it justifies the averaging strategy Hydra employs over multiple anchor combinations.

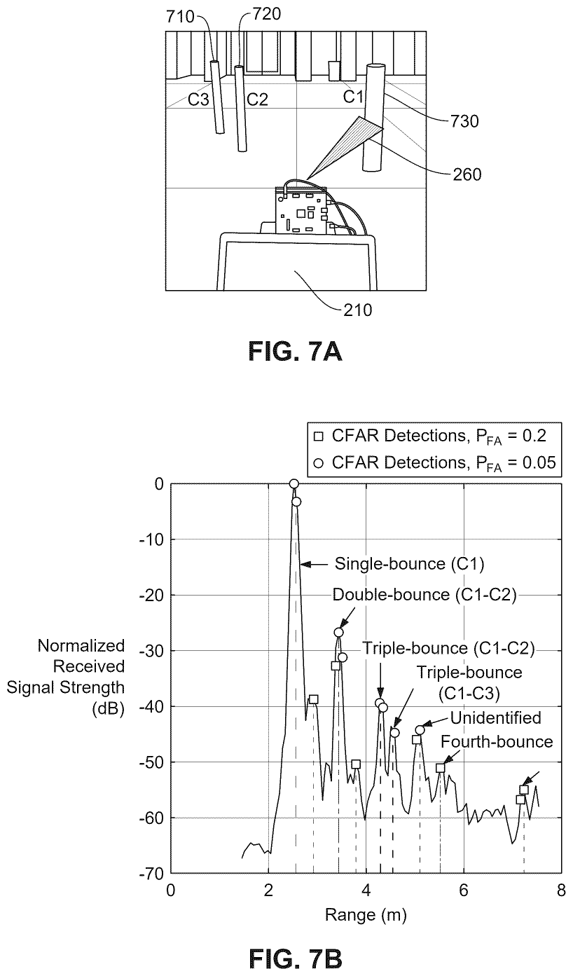

Turning to FIGS. 7A and 7B, FIG. 7A presents an exemplary diagram and FIG. 7 shows a graph describing experimental validation of the signal strength limitation for fourth-bounce reflections. FIG. 7A shows a radar reflectivity profile in a controlled environment containing three metallic cylinders, C1 (710), C2 (720), and C3 (730), arranged to produce reflections of increasing bounce order. The radar (210) transmits toward C1 (710), and multi-bounce paths are constructed using C2 (720) and C3 (730). The plot displays the normalized reflectivity corresponding to several bounce paths including the single-bounce for C1, double-bounce for C1 and C2, triple-bounce for C1, C2, and C3, and fourth-bounce involving all three cylinders. While single-bounce, double-bounce, and triple-bounce returns produce distinct peaks in FIG. 7B in the reflectivity domain, the fourth-bounce signal is nearly indistinguishable from background clutter, demonstrating that its power is too weak to be used reliably. This supports Hydra's design decision to limit sensing to third-order reflections and discard higher-order paths due to their poor signal-to-noise characteristics.

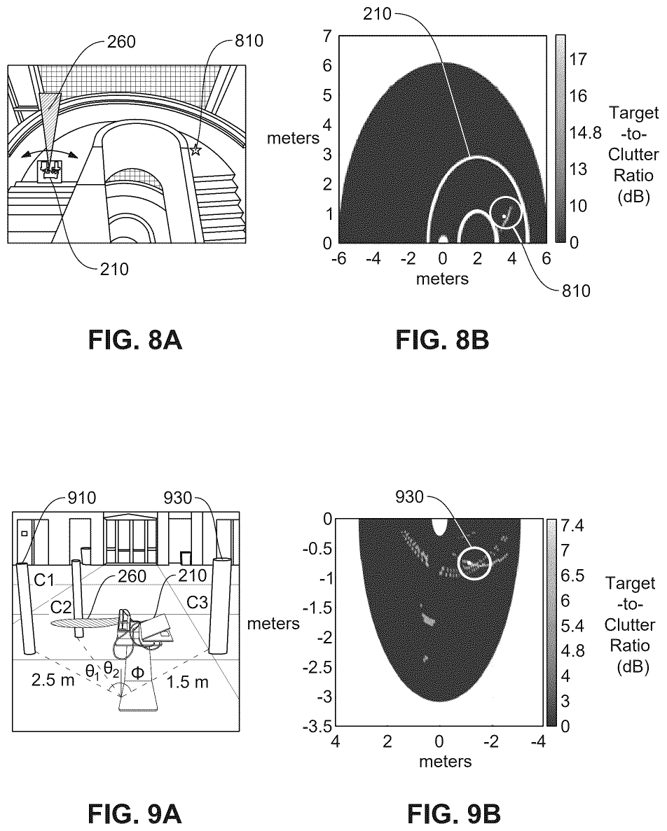

FIGS. 8A and 8B show and exemplary diagrams of Hydra's ability to localize a human target through triple-bounce paths in a scenario where the radar and the human are on opposite sides of a U-shaped staircase bend. In FIG. 8A, the experimental setup shows the radar (210) positioned to transmit within an angular range of [−30°, 30°], capturing reflections off multiple points along the staircase bend. These reflections are used as single-bounce and double-bounce anchors. FIG. 8B displays the result after triple-bounce processing where the human (810), not directly visible to the radar, is successfully localized.

Turning to FIGS. 9A and 9B, FIGS. 9A and 9B show and exemplary diagrams that demonstrate Hydra's ability to perform triple-bounce sensing to localize an object behind the radar. In FIG. 9A, the experimental setup is shown. The radar (210) transmits the beam (260) toward Cylinder C1 (910), with C3 (930) placed such that C3 (930) lies behind the radar's (210) main field-of-view. FIG. 9B shows the result of triple-bounce processing. Two possible triple-bounce paths are considered: (1) radar→C1→C3→C1→radar, and (2) radar→C1→C3→C2→radar. The triple-bounce reflectivity output shows two arcs, each corresponding to one of the paths, and both intersect at the true location of C3 (930).

The present method does not require any prior knowledge of the environment reflectivities, hence enabling a single millimeter-wave system to image beyond its single-bounce field-of-view without additional hardware like lidars. Moreover, the method may handle an arbitrary number of bounces, unlike already existing methods specific to triple-bounce. Variations may include imaging mobile objects (e.g., by including Doppler processing in the above procedure), reducing computational complexity by incorporating sparsity constraints about the environment, etc.

The present method has numerous applications. Specifically, the method may be used in emergency services during disasters to localize people trapped in fires or soldiers wearing helmets outfitted with radars to get information about the surrounding behind them providing situational awareness. Further, the application to supply chain inventory management may help with finding stacked and often hidden inventory in large, warehouses. The method may detect the presence of people throughout a house/office space for HVAC energy management, elderly fall detection or whole-house AR/VR gaming. Additionally, the method may aid autonomous vehicles in blind-spot detection of other vehicles and pedestrians without requiring multiple radar modules mounted on the vehicle to cover the entire 360-degree view.

This disclosure enables imaging beyond-field-of-view objects, e.g., around-corners, behind-the-system and behind-occlusions, with a single millimeter-wave multiple-input multiple-output radar, via an arbitrary number of bounces and without any prior knowledge about the environment or additional hardware like lidars.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method comprising:
transmitting, using a radar, a radar signal based on a fixed transmit beam pattern;
receiving, using the radar, a plurality of reflections of the transmitted radar signal from a plurality of objects in an environment, wherein the reflections may be single-bounce reflections, double-bounce reflections, and triple-bounce reflections and wherein no data about the environment is received;
performing, using a computer processor, a single-bounce matched filtering to localize a first plurality of objects based on the received single-bounce reflection;
performing, using the computer processor, a double-bounce matched filtering to localize a second plurality of objects based on the received double-bounce reflection and the localized first plurality of objects;
performing, using the computer processor, a triple-bounce matched filtering to localize a third plurality of objects based on the received triple-bounce reflection, the localized first plurality of objects and, the localized second plurality of objects; and
generating, using the computer processor, a map that includes the plurality of objects localized by the single-bounce matched filtering, the double-bounce matched filtering, and the triple-bounce matched filtering.

2. The method of claim 1, wherein a multi-bounce matched filtering is terminated when a reflectivity signal strength associated with a next bounce falls below a predefined threshold.

3. The method of claim 1, wherein the received plurality of reflections of the transmitted radar signal is pre-processed using a multi-bounce spatial domain matched filtering, a zero-Doppler extraction, and a background subtraction.

4. The method of claim 1, wherein the localization is performed using an ordered-statistics constant false alarm rate (OS-CFAR) detector applied to a plurality of reflectivity power values.

5. The method of claim 1, wherein the received plurality of reflections of the transmitted radar signal are stored as a radar data cube.

6. The method of claim 1, wherein a multi-bounce matched filtering is based on a model of multi-bounce scattering.

7. The method of claim 1, wherein localization of the plurality of objects comprises:
computing, using the computer processor, a target-to-clutter ratio for a plurality of locations in the environment;
comparing, using the computer processor, the target-to-clutter ratio to a predetermined threshold.

8. The method of claim 4, wherein where the reflectivity power at a plurality of locations is defined as a reflectivity intensity, and
wherein a clutter power is defined based on the reflectivity intensity of points around the plurality of locations.

9. The method of claim 7, wherein the plurality of locations, where the target-to-clutter ratio exceeds the predetermined threshold, are classified as a plurality of detected objects.

10. A system, comprising:
a millimeter wave radar,
wherein the millimeter wave radar transmits a plurality of radar signals in a set of fixed directions, and
wherein the millimeter wave radar receives a plurality of reflected signals, wherein the plurality of reflected signals is the plurality of radar signals reflected from a plurality of surrounding objects and wherein no data about the environment is received; and
a computer communicably connected to the millimeter wave radar, the computer comprising a processor and a memory, the memory storing instructions that, when executed by the processor, cause the processor to:
perform a single-bounce matched filtering to localize a first plurality of objects based on the received single-bounce reflection;
perform a double-bounce matched filtering to localize a second plurality of objects based on the received double-bounce reflection and the localized first plurality of objects;
perform a triple-bounce matched filtering to localize a third plurality of objects based on the received triple-bounce reflection, the localized first plurality of objects and, the localized second plurality of objects; and
generate a map that includes the plurality of objects localized by the single-bounce matched filtering, the double-bounce matched filtering, and the triple-bounce matched filtering.

11. The system of claim 10, wherein a multi-bounce matched filtering is terminated when a reflectivity signal strength associated with a next bounce falls below a predefined threshold.

12. The system of claim 10, wherein the received plurality of reflections of the transmitted radar signal is pre-processed using a multi-bounce spatial domain matched filtering, a zero-Doppler extraction, and a background subtraction.

13. The system of claim 10, wherein the localization is performed using an ordered-statistics constant false alarm rate (OS-CFAR) detector applied to a plurality of reflectivity power values.

14. The system of claim 10, wherein the received plurality of reflections of the transmitted radar signal are stored as a radar data cube.

15. The system of claim 10, wherein a multi-bounce matched filtering is based on a model of multi-bounce scattering.

16. The system of claim 10, wherein localization of the plurality of objects comprises:
computing, using the computer processor, a target-to-clutter ratio for a plurality of locations in an environment;
comparing, using the computer processor, the target-to-clutter ratio to a predetermined threshold.

17. The system of claim 13, wherein where the reflectivity power at a plurality of locations is defined as a reflectivity intensity, and
wherein a clutter power is defined based on the reflectivity intensity of points around the plurality of locations.

18. The system of claim 16, wherein the plurality of locations, where the target-to-clutter ratio exceeds the predetermined threshold, are classified as a plurality of detected objects.

19. A non-transitory computer-readable medium storing instructions that, when executed by a processor, cause the processor to perform a method comprising:
perform a single-bounce matched filtering to localize a first plurality of objects based on a received single-bounce reflection, wherein the received single-bounce reflection includes a plurality of reflections of a transmitted radar signal from a plurality of objects in an environment;
perform a double-bounce matched filtering to localize a second plurality of objects based on the received double-bounce reflection and the localized first plurality of objects;
perform a triple-bounce matched filtering to localize a third plurality of objects based on the received triple-bounce reflection, the localized first plurality of objects and, the localized second plurality of objects; and
generate a map that includes the plurality of objects localized by the single-bounce matched filtering, the double-bounce matched filtering, and the triple-bounce matched filtering.

20. The non-transitory computer-readable medium of claim 19, wherein a multi-bounce matched filtering is terminated when a reflectivity signal strength associated with a next bounce falls below a predefined threshold.
